(19) United States
(12) Patent Application Publication
(10) Pub. No.: US 2011/0054980 A1
(43) Pub. Date: Mar. 3, 2011

(54) GAME REVENUE OPTIMIZATION SYSTEM

(76) Inventors: Dave Simons, Toronto (CA); Kelly Slough, Northampton, MA (US)

(21) Appl. No.: 12/552,622

(22) Filed: Sep. 2, 2009

(51) Int. Cl. G06Q 10/00; G06F 17/30; G06F 15/16; G06Q 50/00

(52) U.S. Cl. 705/10; 705/7; 709/204; 707/E17.014; 707/E17.044

(57) ABSTRACT

A revenue optimization system has a data tier for receiving data related to revenue generation factors for a computer program or a website. The data tier derives at least one metric based on the received data. A revenue optimization engine receives the metric and determines an optimized revenue generation configuration based on the metric. The revenue optimization engine generates a policy to optimize the revenue generation of the computer program or the website based on the determined optimized revenue generation configuration and communicates the policy to the computer program or the website where the policy is implemented.

### FIELD

The subject of the disclosure relates generally to revenue generation within a computer software environment. More specifically, the disclosure relates to a revenue optimization system that includes a revenue optimization engine for optimizing revenue generated by computer programs such as software games and by websites.

### SUMMARY

Software games have a revenue lifecycle. As a game ages, purchase revenue decreases, i.e., conversion rates drop. General wisdom in the gaming community suggests that the bulk of a game's purchase revenue is generated in the first three months after the game is released. As conversion rates drop, alternative techniques are utilized to generate revenue. For example, prices are reduced, in-game advertisements are introduced to trial versions of the game, and the trial durations of these trial versions are increased.

There are numerous factors that affect the revenue generated from software games. These factors may often be game-specific, publisher-specific, or geographic region-specific. In addition, many websites or game portals offer many hundreds and even thousands of games for a user to choose from. Accordingly, in order to maximize revenue generation, revenue generation factors must be managed on a game-specific, publisher-specific, or geographic region-specific basis. To further complicate matters, as a game ages, the effect of these various factors on the revenue generation for a particular game changes, thus requiring frequent and repeated assessments of the factors. As such, manual management of these revenue generation factors becomes economically infeasible as the number of games that must be managed increases.

Described herein is a method and an automated revenue optimization system for optimizing the pricing, packaging, and advertising associated with selected software games and websites. The system collects and analyzes various data and information corresponding to the selected software games and websites. Various metrics are compiled and an optimization algorithm is incorporated to produce an optimized revenue configuration based on the various compiled metrics. Policies are then generated based on the optimized revenue configuration and the policy is transmitted to the associated software games and websites for implementation. Policies can be generated and communicated to games and websites on a per game basis, on a geographic area-specific basis, on a website-specific basis, on a publisher-specific basis, or on any other basis convenient for the specific application. In this way, the revenue optimization system described herein is able to automate the selection of pricing, trial duration, in-game advertising, and other revenue-related options over the life of a software game with the objective of extracting optimal total revenue from a combination of purchase revenue and advertising revenue.

A representative embodiment includes a method for optimizing revenue of a computer program or a website. The method can include receiving data related to the computer program or a website at a revenue optimization engine, determining an optimized revenue generation configuration for the computer program or the website based at least in part on the received data, generating a policy based at least in part on the optimized revenue generation configuration, and communicating the policy from the revenue optimization engine to a policy server.

In a second representative embodiment, an apparatus include an optimization component and a policy generator. The optimization component receives data related to a computer program or a website from a data tier and determines an optimized revenue generation configuration for the computer program or the website based at least in part on the received data. The policy generator generates a policy based at least in part on the optimized revenue generation configuration and communicates the policy from the revenue optimization engine to a policy server.

A third representative embodiment includes a revenue optimization system that has a data tier for receiving data related to revenue generation factors for a computer program or a website. The data tier derives at least one metric based on the received data. A revenue optimization engine receives the metric and determines an optimized revenue generation configuration based on the metric. The revenue optimization engine generates a policy to optimize the revenue generation of the computer program or the website based on the determined optimized revenue generation configuration and communicates the policy to the computer program or the website where the policy is implemented.

Other principal features and advantages will become apparent to those skilled in the art upon review of the following drawings, the detailed description, and the appended claims.

### BRIEF DESCRIPTION OF THE DRAWINGS

Representative embodiments are hereafter described with reference to the accompanying drawings.

FIG. 1 is a block diagram illustrating a system for optimizing revenue from a software game in accordance with a representative embodiment.

FIG. 2 is a block diagram illustrating a revenue optimization engine in accordance with a representative embodiment.

FIG. 3 is a flow diagram illustrating operations of a revenue optimization system of FIG. 1 in accordance with a representative embodiment.

FIG. 4 is a flow diagram illustrating operations of a revenue optimization engine of FIG. 2 in accordance with a representative embodiment.

FIG. 5 is a flow diagram illustrating operations of a revenue optimization system of FIG. 1 in accordance with a representative embodiment.

### DETAILED DESCRIPTION

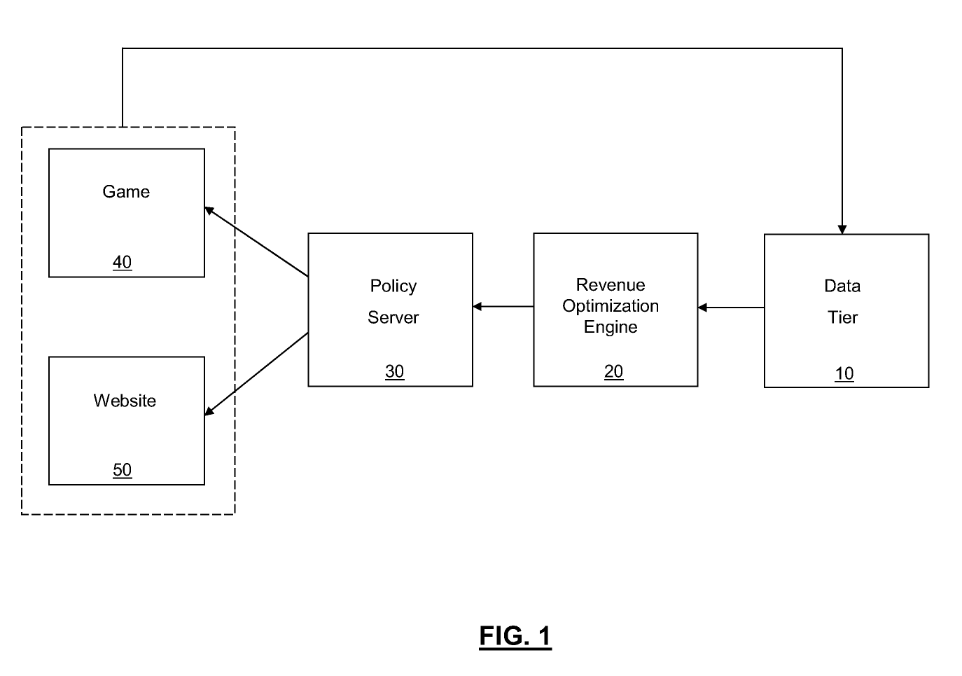

FIG. 1 is a block diagram illustrating a system for optimizing revenue from a software game in accordance with a representative embodiment. According to an embodiment, the system is directed to optimize revenue from a computer program such as a software game or from a website capable of hosting various downloadable computer programs. Note that a “software game” is described throughout the specification and is thereby used merely as an example. The use of a “software game” is not intended to be limiting, and any other suitable type of computer program may be utilized by the systems and methods described below in place of a “software game.” A person of skill in the art will recognize that the tools and operations described below may also be applied to other types of computer programs, media, and games in order to maximize revenue generation.

A revenue optimization engine 20 is communicatively coupled to a data tier 10. In an embodiment, data tier 10 is an online analytical processing database or other suitable database. In an alternative embodiment, data tier 10 may be a server communicatively coupled to an internal or external database. Data tier 10 has three primary responsibilities, although different embodiments may include more or fewer responsibilities. Data tier 10 collects from a variety of sources various data and information affecting revenue generation of a software game or website. For example, data tier 10 may collect information relating to consumer game play, purchases of games, and advertisement-inventory (ad-inventory) of advertisement-enabled (ad-enabled) games from various websites, web portals, or online games. In alternative embodiments, different types of data or information about software games, websites, computer programs, media, etc. may be collected. Data tier 10 may also collect information from web crawlers or spiders used to investigate competitor's websites. These spiders may relay information about the prices of a competitor's games, availability of a competitor's games, most popular games, etc. on a competitor's website.

Data tier 10 may also be configured to aggregate the various collected data into metrics for use by revenue optimization engine 20. For example, data tier 10 may use collected data relating to a number of purchases of a selected game and a number of downloads of a trial version of a game to infer a conversion rate metric for the selected game. Data tier 10 may be further configured to construct metrics based on various pre-determined boundaries. For example, data tier 10 may develop metrics based on specific portals, websites, games, publishers, or geographic regions.

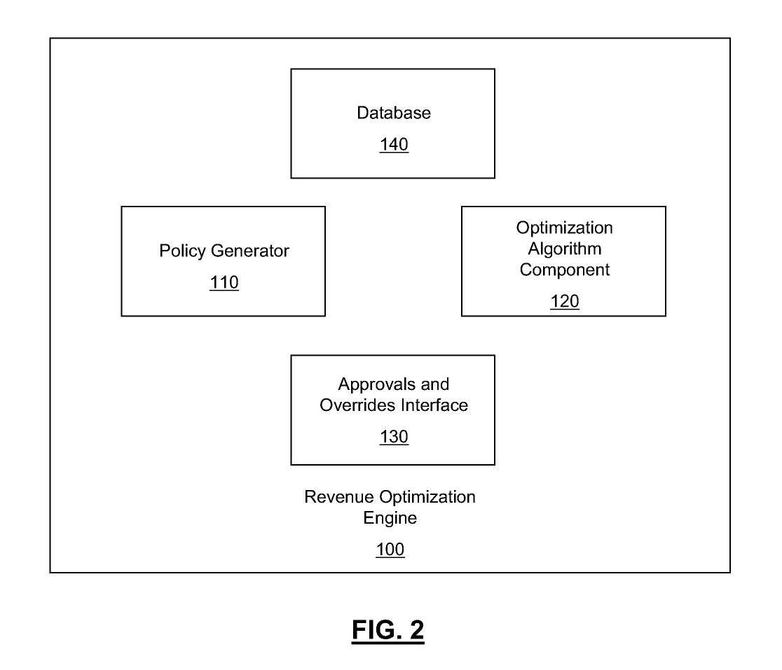

Revenue optimization engine 20 uses the metrics developed by data tier 10 to develop policies to maximize revenue. The revenue optimization engine 20 will be discussed in more detail below with reference to FIG. 2. Based on the metrics, the revenue optimization engine 20 pushes policy updates to a policy server 30.

Policy server 30 communicates the policy updates to various consumer interaction points, such as a software game 40 or a website 50. In an embodiment, software game 40 is an advertisement-enabled software game and website 50 is a website having links to a multitude of downloaded software games. In a representative embodiment, the policies are communicated in one of three policy documents, although alternative embodiments may include additional or different policy documents. A first policy document may be an advertisement-policy document which may control the types and configurations of the presentation of advertisements in an ad-enabled game. A second policy document may be a digital rights management (DRM) policy document which may control the digital rights management for a particular game. A third policy document may be a rich site summary (RSS) document or feed. A website may use the RSS feed to define available games, descriptions of the games, prices, trial durations of various games, and any other conceivable parameter relating to revenue generation. In an embodiment, the policy documents are secured XML documents. The policy updates may include and be based on an individual game, publisher, or website or portal name. In addition, policy server 30 may be geographically-aware in that games played and websites rendered in different geographic locations may be served by different geographic-specific policies.

Consumer interaction points such as game 40 and website 50 apply the policy changes through metadata that is read upon the playing of game 40 or the rendering of website 50. When game 40 is launched, it requests advertisement and DRM policies to establish appropriate game parameters such as trial duration, price, ad appearance (i.e., pre-roll, post-roll, interstitial, overlay, etc.), and ad frequency. Similarly, each time website 50 is rendered it uses an RSS feed to define various parameters such as available games, game descriptions, prices, and trial durations. The policy updates transmitted by policy server 30 modify these requested parameters in order to maximize revenue generation according to revenue optimization engine 20. In this way, factors affecting revenue generation may be easily and repeatedly changed, because website 50 need only be built once and game 40 need only be packaged once.

FIG. 2 is a block diagram illustrating a revenue optimization engine 100 in accordance with a representative embodiment. Revenue optimization engine 100 of FIG. 2 corresponds to revenue optimization engine 20 of FIG. 1. Revenue optimization engine 100 may be stored on a memory of a computer as a computer-readable medium. The memory may be operatively connected to a CPU such as a server which may process the computer-readable medium thereby running revenue optimization engine 100. In addition, the CPU and the memory may be connected to a display which is configured to present visual representations of revenue optimization engine 100 to a user. Alternatively, revenue optimization engine 100 may be considered the entire CPU or the entire server.

Revenue optimization engine 100 includes an optimization algorithm (OA) component 120 that is configured to periodically query data tier 10 (of FIG. 1) and to receive various metrics compiled by data tier 10. Using these received metrics OA component 120 makes recommendations on policy changes to optimize revenue generation from corresponding games and websites. The policy change recommendations are stored in a database 140 of revenue optimization engine 100. In an alternative embodiment, database 140 may be separate and external from revenue optimization engine 100. The policy change recommendations may be automatically approved by policy generator 110 or may be manually approved via an approvals and overrides (AAO) interface 130. A policy generator 110 periodically searches database 140 for approved policy change recommendations. If policy generator 110 discovers an approved policy change recommendation, policy generator 110 generates a new policy pursuant to the policy change recommendation and transmits the new policy to policy server 30 (of FIG. 1).

OA component 120 samples metrics from data tier 10 and determines an optimized revenue configuration in order to optimize revenue from selected games and websites. The optimized revenue configuration may include an optimized advertisement and/or DRM configuration for the selected games and websites. OA component 120 executes an optimization algorithm to determine the optimized revenue configuration. If a determined configuration is different from a current configuration, OA component 120 writes a policy change recommendation in database 140. Any outstanding policy change recommendations for the selected game or website existing in database 140 upon submission of a new change recommendation is marked as “ignore” prior to writing the new policy change recommendation to database 140.

In an embodiment, OA component 120 and its optimization algorithm may be configured by a user. For example, a user may select various characteristics of OA component 120 such as a simplified manual configuration that is based entirely on revenue generation or an advanced machining learning algorithm. In an alternative embodiment, certain configuration parameters may be common to all optimization algorithms. For example, in such an embodiment, a user may enter inputs into revenue optimization engine 100 for the assessment frequency, assessment time, and various competition parameters. The assessment frequency parameter controls how frequently the revenue optimization engine assesses a portal's or a game's configuration. The assessment time controls what time of day, week, month, or year, etc. the revenue optimization engine assesses a game's or a portal's configuration. The competition parameter controls which other portals are considered competitors and may be used to help make pricing recommendations.

In an embodiment, a user may specify use of a manual optimization algorithm by OA component 120. The manual optimization algorithm allows a user to maximize control over the algorithm. The manual optimization algorithm allows a user to configure revenue optimization engine 100 to set game prices, DRM configurations, and ad configurations based on a stage of life of a selected game (i.e., a game stage of life (GSoL)). GSoL is a function of the age of the game based on the time between a game's release date and the present date. The user sets various rules for the operation of revenue optimization engine 100 and the manual optimization algorithm recommends policy changes to best implement these rules.

Upon configuration of the manual optimization algorithm, the user may input several configuration options for defining the operation rules for revenue optimization engine 100. Fewer or more configuration options may be presented to the user depending on the embodiment. In a representative embodiment, the configuration options include a GSoL units configuration option, a GSoL configuration option, a granularity configuration option, a price configuration option, a trial duration configuration option, and an ad frequency configuration option. The GSoL units configuration option controls the units (i.e., days, weeks, months, etc.) which are used to calculate the GSoL. The GSOL configuration option controls the game age specified by the user. A granularity configuration option controls the number of options presented to a user for configuring the GSoL configuration. For example, a high granularity allows the user to choose between five GSoL configuration options (beginning, beginning/middle, middle, middle/end, and end). A low granularity allows the user to choose between three GSoL configuration options (beginning, middle, and end).

A price configuration option controls how the price of a selected game is determined. In a representative embodiment, the price configuration option presents four possibilities: a fixed price, a lowest of a competitor's price, an average of a competitor's price, or a highest of competitor's price. In an alternative embodiment, the currency of the price may also be selected. An override pricing option may be presented in addition to the default pricing option. As such, the override pricing option allows a user to define a price on a per game or per publisher basis. In another embodiment, a price may be defined for a specific geographic region.

A trial duration option controls the trial duration of a game. The trial duration option may present several possible durations such as 30 minutes, 60 minutes, 90 minutes, 120 minutes, 180 minutes, and unlimited. A fixed default trial duration can be specified and an override trial duration may be specified based on a selected game or selected publisher. In addition, different default trial durations may be specified based on a geographic region.

An ad frequency option controls how and when different types of advertisements may appear in a game. For example, the ad frequency option may specify if a pre-roll ad should appear, if and at what frequency an interstitial ad should appear, if and at what frequency an overlay ad should appear, and if a post-roll ad should appear. Similar to the pricing and trial duration options, default ad frequency options can be specified and an override ad frequency option can be specified for selected games, publishers, and geographic regions.

In another embodiment, an experiential optimization algorithm (EOA) or machine learning algorithm may be utilized by OA component 120. The EOA observes consumer game play and purchase behavior and infers a GSoL from these observations. In an embodiment, these observations are made by analyzing metrics compiled by data tier 10. For example, the EOA may analyze a time series of conversion rates or a time to purchase curve to determine the GSoL of a selected game.

In an embodiment, a user may input configuration options in a similar manner as for a manual optimization algorithm. In another embodiment, no configuration option is input by a user for the GSoL, the trial duration, and the ad frequency. Instead the EOA calculates the GSoL, the trial duration, and the ad frequency based on metrics received from data tier 10.

In an alternative embodiment, a customized optimization algorithm may be created and utilized by a third party.

AAO interface 130 provides a user interface by which a user may configure various parameters of revenue optimization engine 100. In a representative embodiment, AAO interface 130 provides a user interface configured to display and receive the various configuration parameters for the manual optimization algorithm discussed above as well as configuration parameters for policy generator 110. AAO interface 130 may also receive approval indications approving policy change recommendations stored in database 140. In an embodiment, AAO interface 130 may also receive policy overrides which allow a user to override policy recommendations made by OA component 120 and generate new policies.

Policy generator 110 is responsible for selecting all outstanding approved policy change recommendations from database 140, generating a new policy based on the policy change recommendation, and pushing the new policy to policy server 30. Upon completion of the pushing the new policy to policy server 30, policy generator 110 marks the policy change recommendation as implemented. A policy change recommendation will only be implemented if the recommendation is approved. In various embodiments, the policy change recommendations may be approved by a revenue manager via AAO interface 130 or automatically by policy generator 110.

In an embodiment, policy generator 110 has several configurable parameters such as a policy generation frequency, a policy generation time, must approve games, etc. The policy generation frequency controls how frequency policy generator 110 searches database 140 for outstanding approved policy change recommendations. The policy generation time controls the specific time of day that policy generator 110 searches database 140. The must approve games parameter indicates criteria that if satisfied by a game or website requires policy generator 110 to automatically approve a policy change recommendation for the game or the website. For example, the criteria may include a specific set of games, all games for a specific set of publishers, all games with an average number of daily downloads over a selected time period exceeding a threshold, all games with an average number of daily purchases over a selected time period exceeding a threshold, all games younger than a selected age, and any other suitable criteria. In an embodiment, the criteria for the must approve games parameter may be configured by a revenue manager or person authorized to set parameters of revenue optimization engine 100 via AAO interface 130 or a similar component.

In addition to storing policy change recommendations from OA component 120, database 140 may also store revenue optimization engine state information, policy generator 110 actions, and approvals and overrides received by AAO interface 130. Database 140 may also store custom state information of OA component 120. For example, in an embodiment, as OA component 120 executes its optimization algorithm, it writes trace level decision information to database 140. Using this trace level decision information, a report may be generated detailing how the policy change recommendations were created and how they should be understood. In addition, database 140 may store any and all configuration changes in a configuration transaction log. Reports can then be generated using the transaction log detailing any configuration changes.

Using information stored in database 140, revenue optimization engine 100 can generate various reports. For example, the reports may include information regarding the OA component used, the OA component configuration and published policy, any outstanding recommended policy changes, OA component audit trails (i.e., why the OA component is making a recommendation), user audit trails (i.e., who is approving, rejecting, and overriding policy recommendations), operational details, etc. In an embodiment, the reports are accessible via a self service portal or website. The self service portal or website may be maintained and controlled by an administrator. Access to the self service portal or website may be restricted to authorized entities by using any combination of a portal name, a user name, a password, etc.

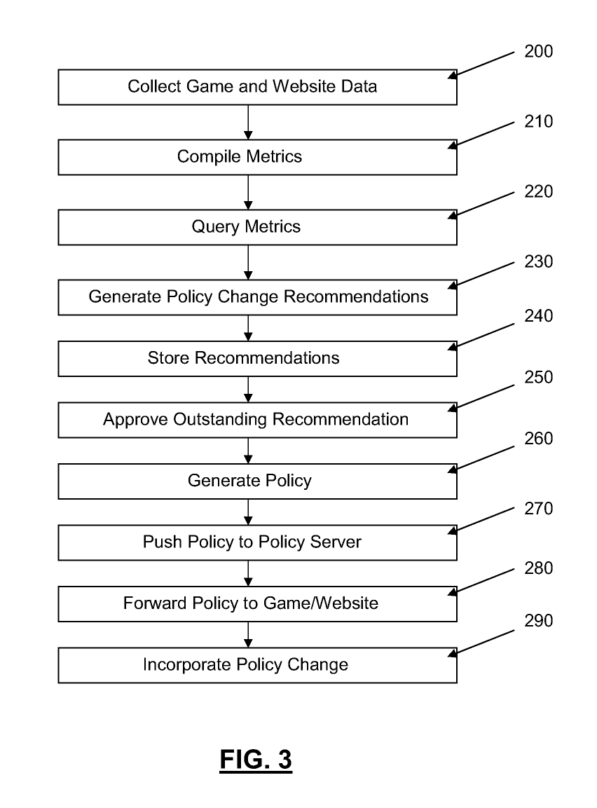

FIG. 3 is a flow diagram illustrating operations of a revenue optimization system of FIG. 1 in accordance with a representative embodiment. Additional, fewer, or different operations may be performed depending on the particular implementation. In an operation 200, a data tier collects various data from various software games and websites. This various data may include information relating to consumer game play, purchases of games, competitors games and prices, and ad-inventories from various websites, portals, or online software games. The data tier aggregates the collected data and produces metrics related to the revenue generation ability of selected software games and websites, in an operation 210.

A revenue optimization engine (ROE) queries the data tier for the metrics in an operation 220. In an operation 230, an optimization component of the ROE generates policy change recommendations based on the queried metrics. In an operation 240, the optimization component stores the policy change recommendations to a database of the ROE. In an operation 250, the policy change recommendations are approved either manually by an authorized user or automatically by the ROE. A policy generator of the ROE generates the policy based on the approved policy change recommendation in an operation 260. The policy generator then pushes the policy to a policy server in an operation 270, and the policy server forwards the policy to the appropriate game(s) or website(s) in an operation 280. In an operation 290, the policy changes are incorporated by the game(s) when they are played or by the website(s) when they are rendered.

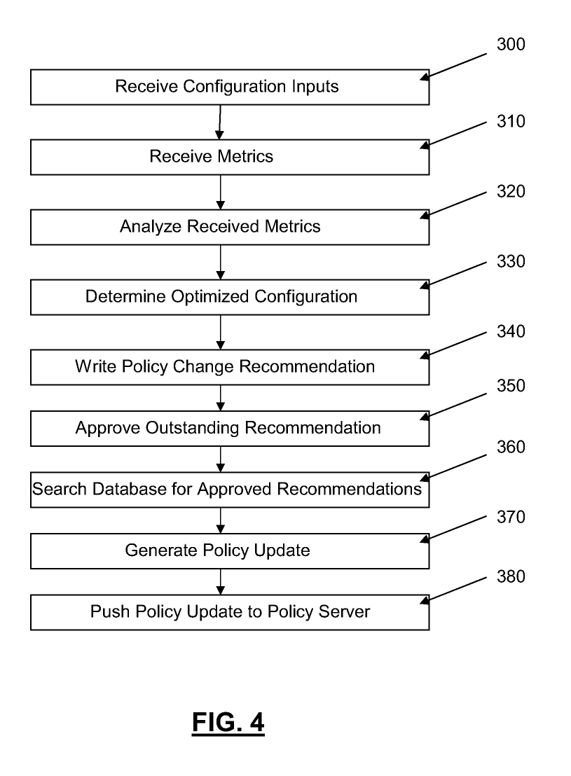

FIG. 4 is a flow diagram illustrating operations of a revenue optimization engine of FIG. 2 in accordance with a representative embodiment. Additional, fewer, or different operations may be performed depending on the particular implementation. In an operation 300, a revenue optimization engine (ROE) receives configuration inputs for an optimization algorithm. In an embodiment, the configuration inputs are received via a user interface of the ROE. In an operation 310, an optimization component of the ROE receives metrics from a data tier. The metrics concern data and information regarding revenue optimization factors of selected games and websites.

The optimization component analyzes the received metrics in an operation 320. In an operation 330, the optimization component determines an optimized configuration for a selected game or website which would maximize the revenue of the selected game or website or otherwise satisfy rules established by the configuration inputs received in operation 300 and the optimization algorithm of the optimization component. The optimization component writes a policy change recommendation to a database of the ROE in an operation 340. The policy change recommendation includes proposed policy change updates to implement the optimized configuration determined in operation 330.

In an operation 350, the policy change recommendation is approved by either manually by an authorized user or automatically by a policy generator of the ROE. The policy generator periodically searches the database of the ROE for approved outstanding policy recommendations in an operation 360. Once the policy generator has discovered an approved outstanding policy recommendation, the policy generator generates a policy update in an operation 370. In an operation 380, the policy generator pushes the policy update to a policy server which forwards the policy update to the appropriate game(s) and/or website(s). The game(s) and/or website(s) then implement the policy update which is configured to optimize revenue generation by the selected game(s) and/or website(s).

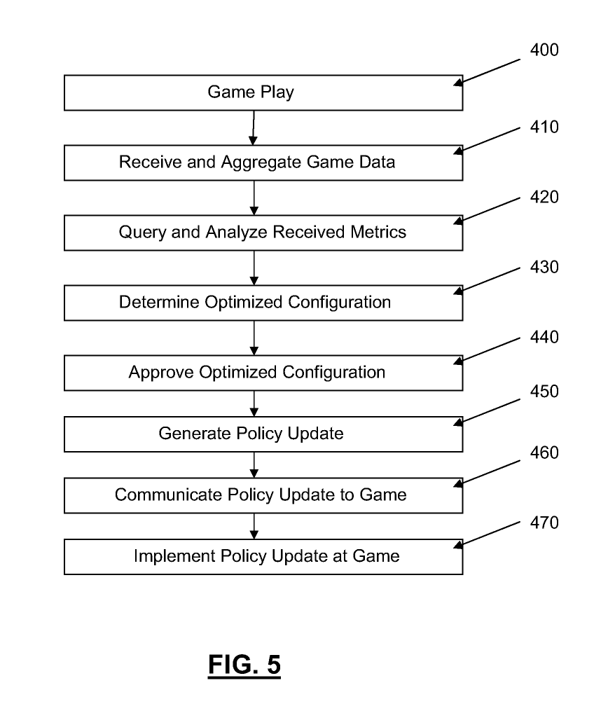

FIG. 5 is a high level flow diagram illustrating operations of a revenue optimization system of FIG. 1 in accordance with a representative embodiment. Additional, fewer, or different operations may be performed depending on the particular implementation. In an operation 400, an online or downloadable software game is played by a consumer. In an operation 410, a data tier periodically receives various data from the software game. This various data may include information relating to consumer game play of the software game, purchases of the software game, competitors' prices for a similar or the same software game, and ad-inventories from various websites, portals, or similar online software games. The data tier may also aggregate the received game data and produce metrics related to the revenue generation capability of the software game.

A revenue optimization engine (ROE) periodically queries the data tier for these metrics and analyzes the received metrics in an operation 420. Based on the metrics, the ROE determines a configuration for the software game in which revenue generation for the software game is optimized in an operation 430. For example, the ROE may determine what price at which the game should be sold, what type of advertisements should be included in trial versions of the game, what duration the trial versions of the game should be, etc. in order to maximize revenue generation. In an embodiment, the ROE determines a stage of life of the game based on the metrics received from the data tier and the optimized revenue generation configuration is determined based on the software game's stage of life. For example, if the game is experiencing a relatively high conversion rate (i.e., rate at which consumers are purchasing the game), it may be determined that the game is in an early stage of life (e.g., one in which most revenue is generated from game purchases). However, if the conversion rate is quite low, the game may be in a later stage of life (e.g., one in which most revenue is generated from advertising).

In an operation 440, the ROE approves the optimized revenue generation configuration. In various embodiments, the optimized revenue generation configuration is approved either manually by an authorized user or automatically by the ROE. In an operation 450, the ROE generates a policy update based on the approved optimized revenue generation configuration. The policy update includes a configuration of the software game that may be implemented by the software game in order to maximize revenue according to the optimized revenue generation configuration determined by the ROE. In an operation 460, the ROE then communicates the policy update to a policy server which further communicates the policy update to the software game upon request of the software game.

In an operation 470, the software game implements the received policy update. In an embodiment, implementation of the policy update occurs when the game is next played. For example, when a game is initialized or downloaded, the game may request an advertisement or DRM policy from the policy server. In response to this request, the policy server provides the policy update produced by the ROE. The policy update includes information used by the game to set various parameters such as the trial version duration, the price, the types of ads, the frequency of ads, etc. Upon receiving the policy update, the software game sets the various parameters according to the information included in the policy update. These various parameters then alter the revenue generation of the software game as determined by the ROE. In an embodiment, this process is periodically repeated in order to continually optimize the revenue generation of the software game as the game ages.

It is important to understand that any of the embodiments described herein may be implemented as computer-readable instructions stored on a computer-readable medium. Upon execution by a processor, the computer-readable instructions can cause a computing device to perform operations to implement any of the embodiments described herein.

The foregoing description of exemplary embodiments has been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated. In addition, one or more flow diagrams were used herein. The use of flow diagrams is not intended to be limiting with respect to the order in which operations are performed.

What is claimed is:

1. A method comprising:
receiving data related to a computer program or a website at a revenue optimization engine from a data tier;
determining, at the revenue optimization engine, an optimized revenue generation configuration for the computer program or the website based at least in part on the received data;
generating, at the revenue optimization engine, a policy based at least in part on the optimized revenue generation configuration;
communicating the policy from the revenue optimization engine to a policy server.

2. The method of claim 1, further comprising generating, at the revenue optimization engine, a policy change recommendation based at least in part on the optimized revenue generation configuration; and
approving or receiving an approval of the policy change recommendation.

3. The method of claim 2, wherein the step of generating a policy comprises generating the policy based at least in part on the policy change recommendation.

4. The method of claim 2, further comprising storing the policy change recommendation at a database.

5. The method of claim 4, further comprising searching the database for an approved policy change recommendation.

6. The method of claim 1, wherein the received data comprises at least one metric derived at the data tier based on revenue generation factors of the computer program or the website received at the data tier.

7. The method of claim 1, further comprising receiving configuration inputs at a user interface of the revenue optimization engine, wherein the configuration inputs define operational parameters of the revenue optimization engine.

8. The method of claim 7, wherein the step of determining comprises determining the optimized revenue generation configuration based at least in part on the configuration inputs.

9. The method of claim 7, wherein the configuration inputs comprise at least one of a price, a trial duration, an ad frequency, a game stage of life (GSoL), or a GSoL unit.

10. The method of claim 1, wherein the computer program is a software game.

11. The method of claim 1, further comprising periodically sending a query for the data related to the computer program or the website from the revenue optimization engine to the data tier.

12. The method of claim 1, wherein the policy is directed to at least one of a specific computer program, a plurality of computer programs associated with a specific publisher, or a plurality of computer programs associated with a specific geographic region.

13. The method of claim 1, further comprising generating a report at the revenue optimization engine, wherein the report describes at least one of a history of inputs received by the revenue optimization engine, decisions made by the revenue optimization engine, or how the policy was generated by the revenue optimization engine.

14. The method of claim 1, wherein the policy communicates revenue generation factors for maximizing revenue generation from the computer program or the website.

15. An apparatus comprising:
an optimization component configured to:
receive data related to a computer program or a website from a data tier; and
determine an optimized revenue generation configuration for the computer program or the website based at least in part on the received data; and
a policy generator configured to:
generate a policy based at least in part on the optimized revenue generation configuration; and
communicate the policy from the revenue optimization engine to a policy server.

16. The apparatus of claim 15, wherein the optimization component is configured to generate a policy change recommendation based at least in part on the optimized revenue generation configuration.

17. The apparatus of claim 16, further comprising an interface configured to receive an approval of the policy change recommendation.

18. The apparatus of claim 16, further comprising a policy generator configured to automatically approve the policy change recommendation based on a pre-defined configuration parameter.

19. The apparatus of claim 16, further comprising a policy generator configured to generate the policy based at least in part on the policy change recommendation.

20. The apparatus of claim 15, wherein the data comprises at least one metric derived at the data tier based on revenue generation factors for the computer program or the website received at the data tier.

21. The apparatus of claim 15, further comprising a user interface configured to receive configuration inputs that define operational parameters of the revenue optimization engine.

22. The apparatus of claim 21, wherein the optimization component is configured to determine the optimized revenue generation based at least in part on the configuration inputs.

23. The apparatus of claim 15, wherein the optimization component is configured to determine a stage of life of the computer program based on the received data.

24. The apparatus of claim 15, wherein the policy generator is further configured to automatically approve a policy change recommendation if the computer program satisfies a must approve games parameter.

25. The apparatus of claim 15, wherein the computer program is a software game and the website is configured to provide a plurality of downloadable software games.

26. A method comprising:
receiving, at a data tier, data related to revenue generation factors of a computer program or a website;
deriving at least one metric, at the data tier, based at least in part on the received data;
receiving the at least one metric at a revenue optimization engine;
determining, at the revenue optimizaiton engine, an optimized revenue generation configuration for the computer program or the website based at least in part on the at least one metric;
generating, at the revenue optimization engine, a policy based at least in part on the optimized revenue generation configuration;
communicating the policy from the revenue optimization engine to the computer program or the website for implementation of the policy.

27. The method of claim 26, further comprising generating, at the revenue optimization engine, a policy change recommendation based at least in part on the optimized revenue generation configuration; and
approving or receiving an approval of the policy change recommendation.

28. The method of claim 27, wherein the step of generating a policy comprises generating the policy based at least in part on the policy change recommendation.

29. The method of claim 26, further comprising receiving configuration inputs at a user interface of the revenue optimization engine, wherein the configuration inputs define operational parameters of the revenue optimization engine, and wherein the step of determining comprises determining the optimized revenue generation configuration based at least in part on the configuration inputs.

30. The method of claim 26, wherein the step of communicating the policy comprises sending the policy from the revenue optimization engine to a policy server and sending the policy from the policy server to the software game or the website.

31. A revenue optimization system comprising:
a data tier configured to:
receive data related to revenue generation factors of a computer program or a website;
derive at least one metric based at least in part on the received data; and
a revenue optimization engine configured to:
receive the at least one metric;
determine an optimized revenue generation configuration based at least in part on the at least one metric;
generate a policy to optimize revenue generation of the computer program or the website based at least in part on the optimized revenue generation configuration; and
communicate the policy to the computer program or the website for implementation of the policy.

32. The system of claim 31, wherein revenue optimization engine is configured to generate a policy change recommendation based at least in part on the optimized revenue generation configuration.

33. The system of claim 32, wherein the revenue optimizaiton engine further comprises an interface configured to receive an approval of the policy change recommendation, wherein the revenue optimization engine is further configured to generate the policy based at least in part on an approved policy change recommendation.

34. The system of claim 32, wherein the revenue optimization engine is further configured to automatically approve the policy change recommendation based on a pre-defined configuration parameter, and wherein the revenue optimization engine is further configured to generate the policy based at least in part on an approved policy change recommendation.

35. The system of claim 31, wherein the revenue optimization engine further comprises an interface configured to receive configuration inputs that define operational parameters of the revenue optimization engine, and wherein the revenue optimization engine is configured to determine the optimized revenue generation configuration based at least in part on the configuration inputs.

36. The system of claim 31, further comprising a policy server configured to receive the policy from the revenue optimization engine and send the policy to the computer program or the website.

37. A tangible computer-readable medium having stored thereon, computer-executable instructions that, if executed by a computing device, cause the computing device to perform a method comprising:
receiving data related to a computer program or a website from a data tier;
determining an optimized revenue generation configuration based at least in part on the received data;
generating a policy for the computer program or the website based at least in part on the optimized revenue generation configuration;
communicating the policy to a policy server.

38. The tangible computer-readable medium of claim 37, wherein the computer-executable instructions, if executed by a computing device, further cause the computing device to perform a method comprising:
generating a policy change recommendation based at least in part on the optimized revenue generation configuration; and
approving or receiving an approval of the policy change recommendation.

39. The tangible computer-readable medium of claim 38, wherein the step of generating a policy comprises generating the policy based at least in part on the policy change recommendation.
